(19) United States
(12) Patent Application Publication
(10) Pub. No.: US 2003/0146976 A1
(43) Pub. Date: Aug. 7, 2003

(54) Digital camera system enabling remote monitoring

(76) Inventor: Tai-Li Liu, Hou-Li (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/060,168

(22) Filed: Feb. 1, 2002

(51) Int. Cl. H04N 5/225

(52) U.S. Cl. 348/207.1

(57) ABSTRACT

A digital camera system enabling remote monitoring is provided. The present digital camera system comprises a digital camera module, a programmable logic device, a buffer memory and a central processing unit. The digital camera module sends image data to the programmable logic device and stored in the buffer memory. The central processing unit reads the image data stored in the buffer memory through the programmable logic device and then transmits the image data to a remote monitoring center through a communication network.

### BACKGROUND OF THE INVENTION

1. Field of the Invention

The present invention relates to a digital camera system, and more particularly, to a digital camera system enabling remote monitoring.

2. Description of the Prior Art

In general, a digital camera stores the digital image data in an internal flash memory or an external memory card, and connects with a peripheral display, such as a television and a personal computer. A user can observe various images stored in the digital camera's memory through the screen of the television or personal computer. In case that the user desires to print out the image, the image data stored in the digital camera's memory can be sent to the personal computer connected with a printer. The image can be printed out through the printer by running an application software in the personal computer.

When the digital camera would like to send image data to a remote terminal, the digital camera needs to send the image data to a central processing device with a communication interface. Then, the central processing device transmits the image data through the communication interface by a cable communication network or a wireless communication network to the remote terminal. However, the hardware operation specification of the digital camera is not compatible with that of the central processing device. The image data of the digital camera only can be stored in the internal flash memory or the external memory card, while can not be directly sent to the central processing device. In order to send image data of the digital camera to the remote terminal through a communication network to facilitate the user's operation, a signal conversion circuit is required between the digital camera and the central processing device. The image data of the digital camera can be directly sent to the central processing device via the signal conversion circuit.

Accordingly, it is an intention to provide an improved digital camera system, which can overcome the above issue encountered in the conventional digital camera.

### SUMMARY OF THE INVENTION

It is one objective of the present invention to provide a digital camera system enabling remote monitoring, which can transmit image data to a remote monitoring center by a wireless transmission method, improving convenience for operating the digital camera system and saving the cost for layout and labor work.

It is another objective of the present invention to provide a digital camera system enabling remote monitoring, which can transmit image data through a communication network to a remote monitoring center, and the remote monitoring center can concurrently monitor several digital camera systems through the communication network.

It is a further objective of the present invention to provide a digital camera system enabling remote monitoring, which can support communication functions of an IEEE802.11b wireless communication network.

In order to achieve the above objectives of this invention, the present invention provides a digital camera system enabling remote monitoring. The present digital camera system comprises a digital camera module, a programmable logic device, a buffer memory and a central processing unit. The digital camera module sends image data to the programmable logic device and stored in the buffer memory. The central processing unit reads the image data stored in the buffer memory through the programmable logic device and then transmits the image data to a remote monitoring center through a communication network. The present digital camera system can transmit image data to the remote monitoring center by a wireless communication network, and the remote monitoring center also can concurrently monitor several digital camera systems by the wireless communication network.

### BRIEF DESCRIPTION OF THE DRAWINGS

The objectives and features of the present invention as well as advantages thereof will become apparent from the following detailed description, considered in conjunction with the accompanying drawings.

FIG. 1 is a block diagram of a digital camera system enabling remote monitoring according to one preferred embodiment of the present invention;

FIG. 2 shows internal functional blocks of a programmable logic device of the preferred embodiment of FIG. 1;

FIG. 3 is a flow chart showing the processes for writing in/read out image data of the programmable logic device in the preferred embodiment of the present invention;

FIG. 4A is a timing diagram showing how the image data from a digital camera module is written in a static random access memory according to the preferred embodiment of the present invention; and

FIG. 4B is a timing diagram showing how the central processing unit reads out image data from the static random access memory.

### DESCRIPTION OF THE EMBODIMENTS

The present invention provides a digital camera system enabling remote monitoring, which comprises a digital camera module, a programmable logic device (PLD), a buffer memory and a central processing unit. The digital camera module includes an image capturing unit and an image processing/communication unit. The image capturing unit is used for capturing image information of an object and sending the image information to the image processing/communication unit. After processing to become compressed digital image data by the image processing/communication unit, the compressed digital image data is sent to the programmable logic device. It should be noted that the compressed digital image data from the image processing/communication unit is not standardized compressed digital image data.

The programmable logic device is used as a communication medium between the digital camera module, the buffer memory and the central processing unit. The image data from the digital camera module is sent to the programmable logic device, and then stored in the buffer memory, which is controlled by the programmable logic device. Once upon completion for sending image data to the programmable logic device from the digital camera module, the central processing unit reads out image data stored in the buffer memory through the programmable logic device.

The central processing unit is a kind of central processor with communication function. The central processing unit can transmit image data read from the buffer memory to a remote monitoring center, such as a remote connected computer, through a cable communication network, for example an ethernet. The remote connected computer also can monitor the present digital camera system through the cable communication network. In another respect, the central processing unit can communicate various signals with the remote monitoring center, through a wireless communication interface by a wireless communication network. As a consequence, the central processing unit can transmit the image data read from the buffer memory to the remote monitoring center by a wireless transmission method. The remote monitoring center can also concurrently monitor several digital camera systems by the wireless communication network.

In accordance with the present digital camera system, the remote monitoring center can control various parameters such as image brightness, the amount of the compressed image data executed by the digital camera module, focus, aperture, white balance of the digital camera and other operating parameters thereof, through the cable communication network or the wireless communication network, by the central processing unit. Besides, the present digital camera system can be used as a monitoring video recording system established in the building to improve safety and security of the building.

The present digital camera system enabling remote monitoring and the image data transmission method thereof will be descried in detail by a preferred embodiment of the present invention.

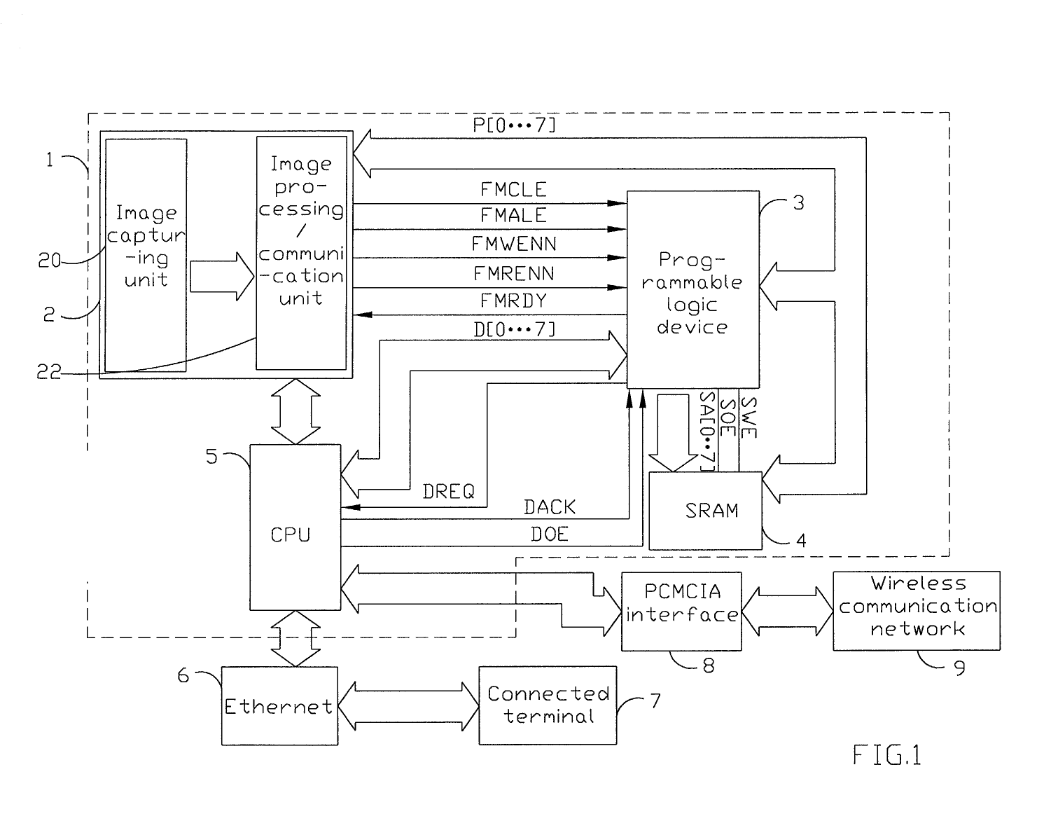

Referring to FIG. 1, which is a block diagram of the present digital camera system 1 according to the preferred embodiment. The schematic functional blocks of a cable communication network and a wireless communication network implemented by the present digital camera system 1 are also shown in FIG. 1. In the preferred embodiment, the digital camera system 1 comprises a digital camera module 2, a programmable logic device (PLD) 3, a static random access memory (SRAM) 4 and a central processing unit 5. The digital camera module 2 includes an image capturing unit 20 and an image processing/communication unit 22. The image processing/communication unit 22 can be an integrated camera chip. The image capturing unit 20 is used for capturing image information of an object and sending the image information to the image processing/communication unit 22. The image information is converted to the compressed digital image data, for example JPEG compressed image data, by the image processing/communication unit 22. It should be noted that the compressed digital image data from the image processing/communication unit 22 is not standardized JPEG compressed image data.

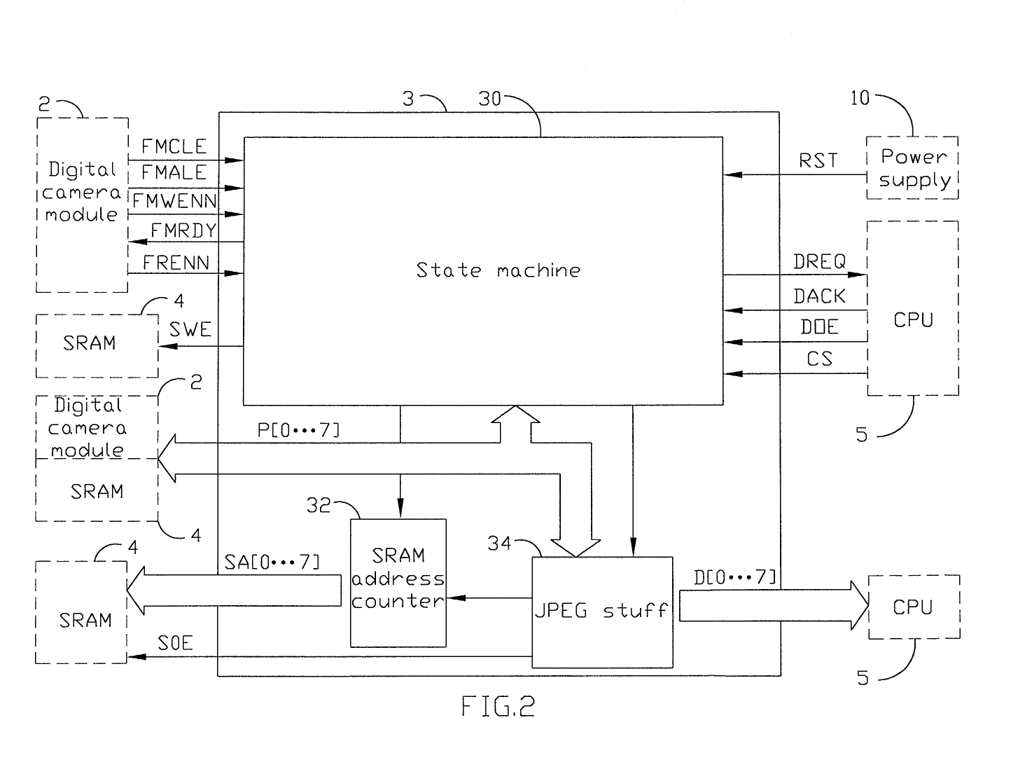

Referring to FIG. 2, which shows internal functional blocks of the programmable logic device 3 of the preferred embodiment. The programmable logic device 3 includes a state machine 30, a SRAM address counter 32 and a JPEG stuff 34. The compressed digital image data from the digital camera module 2 is sent to the programmable logic device 3, and then stored in the static random access memory (SRAM) 4 served as the buffer memory of the digital camera system 1, which is controlled by the programmable logic device 3. Once upon completion for sending image data from the digital camera module 2 to the programmable logic device 3 or the storage volume of the static random access memory 4 is fully occupied, the central processing unit 5 reads image data stored in the static random access memory 4 through the programmable logic device 3 by a direct memory access (DMA) method until the reading cycle is completed, i.e. all the image data stored in the static random access memory 4 are read out.

In the preferred embodiment, the programmable logic device 3 simulates the writing operation of a standard NAND flash memory to write in image data sent from the digital camera module 2. Referring to FIG. 1, the programmable logic device 3 provides eight pins P [0..7] connected with the digital camera module 2. The eight pins P [0..7] are used for communicating address, data and command etc. between the digital camera module 2 and the programmable logic device 3. The eight pins P [0..7] are also used to transmit image data stored in the static random access memory 4 to the programmable logic device 3.

Referring to FIG. 2, the state machine 30 of the programmable logic device 3 is used for receiving, determining and processing communication signals between the programmable logic device 3 and the digital camera module 2, the static random access memory 4, the central processing unit 5 and other peripherals such as a power supply 10. When the present digital camera system 1 is powered on, the power supply 10 sends a reset signal to the state machine 30 of the programmable logic device 3. When the programmable logic device 3 simulates the writing operation of the standard NAND flash memory to write in image data sent from the digital camera module 2, various enable signals required by the writing operation of the standard NAND flash memory, including FMCLA (flash memory command latch enable), FMALE (flash memory address latch enable) and FMWENN (flash memory write enable) are sent to the state machine 30 from the digital camera module 2. Then, the state machine 30 sends a SWE (SRAM write enable) signal to the static random access memory 4, acknowledging the static random access memory 4 to write in image data from the state machine 30. When the static random access memory 4 writes an image data into a selected address, the SRAM address counter 32 counts one. Once upon completing the writing cycle, i.e. writing in all the image data sent from the digital camera module 2, or the storage volume of the static random access memory 4 is fully occupied, the state machine 30 sends a DREQ (direct memory access request) signal to the central processing unit 5, acknowledging the central processing unit 5 for reading in image data stored in the static random access memory 4. Then, the central processing unit 5 sends a DACK (direct memory access acknowledge) signal to the state machine 30. Continually, the JPEG stuff 34 sends a SOE (SRAM output enable) signal to the static random access memory 4. Image data stored in the static random access memory 4 are sent to the JPEG stuff 34 through the eight pins P [0..7]. The JEPG stuff 34 compensates the image data from the static random access memory 4, becoming the standardized JPEG image data D[0..7 ], then sending to the central processing unit 5.

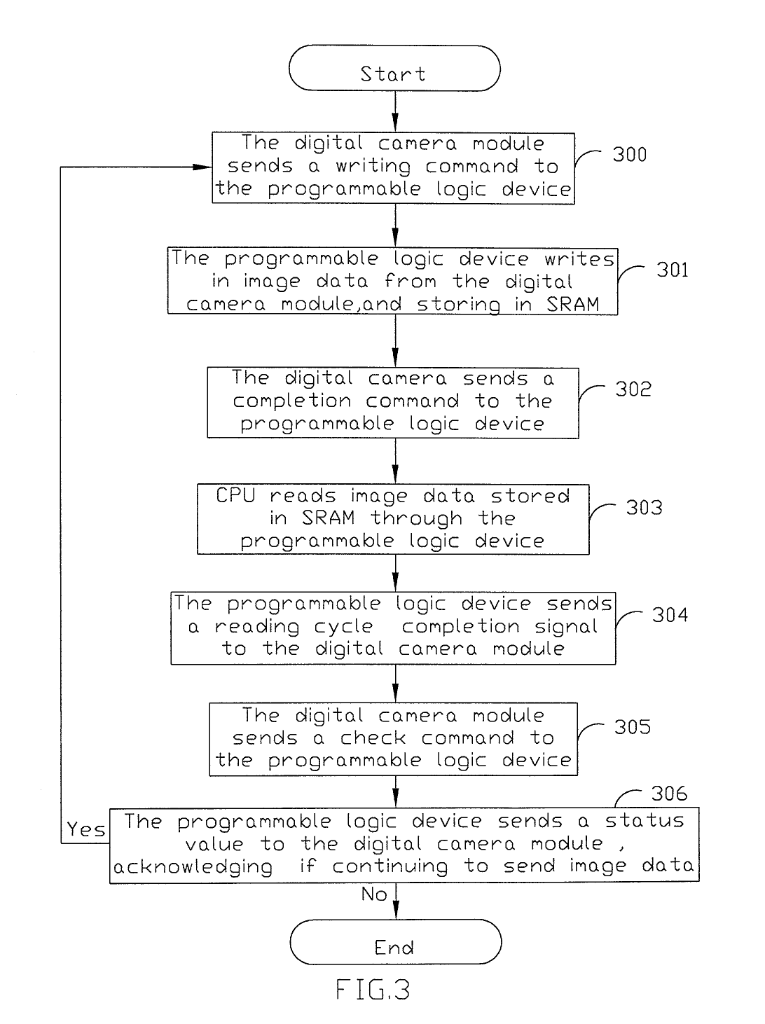

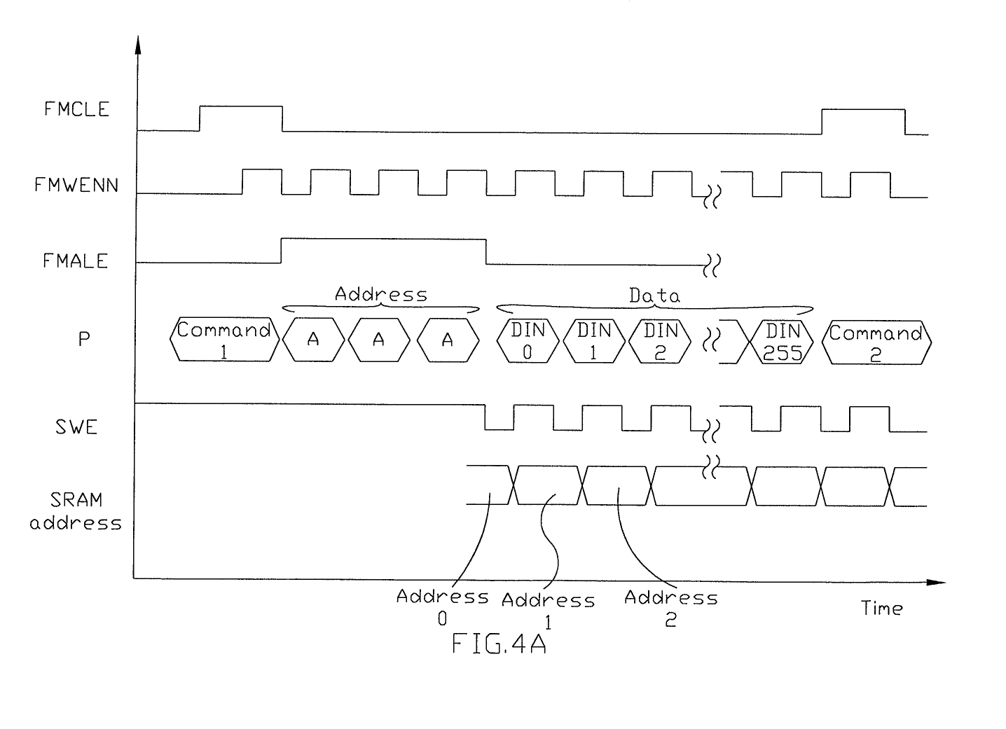

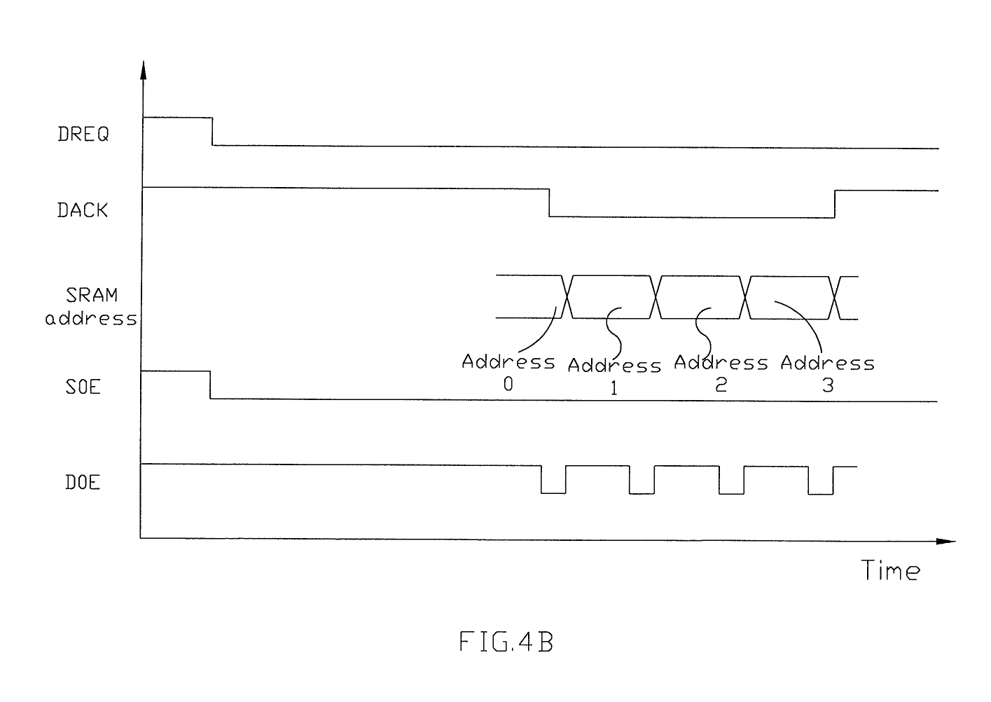

FIG. 3 is a flow chart showing the processes for writing in/read out image data of the programmable logic device 3 of the preferred embodiment. FIG. 4A is a timing diagram showing how the programmable logic device 3 writes in image data from the digital camera module 2 by simulating the writing operation of the standard NAND flash memory, and storing the image data in the static random access memory 4. FIG. 4B is a timing diagram showing how the central processing unit 5 reads out image data stored in the static random access memory 4 through the programmable logic device 3 by the direct memory access (DMA) method.

Referring to FIG. 3 and FIG. 4A, at step 300, the digital camera module 2 sends a writing command (command 1) to the state machine 30 of the programmable logic device 3. The timing diagram of the FMCLE signal, FMWENN signal, FMALE signal, the writing command (command 1), selected addresses and image data to be written in, provided from the digital camera module 2, sending to the state machine 30 through the eight pins P [0..7] of the programmable logic device 3, is shown in FIG. 4A. Continually, at step 301, the programmable logic device 3 writes in the image data sent from the digital camera module 2, and then storing in the static random access memory 4. The state machine 30 sends a SWE (SRAM writing enable) signal to the static random access memory 4. When the static random access memory 4 writes an image data into one selected address (address 0, 1, 2, . . . ), the SRAM address counter 32 counts one. The timing diagram for writing the image data into the static random access memory 4 is shown in FIG. 4A. At step 302, once upon completing the writing cycle, i.e. all the image data sent from the digital camera module 2 are written into the static random access memory 4, the digital camera module 2 sends a completion command (command 2) to the state machine 30 of the programmable logic device 3.

Continually, at step 303, referring to FIG. 3 and FIG. 4B, the state machine 30 sends a DREQ (direct memory access request) signal to the central processing unit 5. Then, the central processing unit 5 sends a DACK (direct memory access acknowledge) signal to the state machine 30, simultaneously sending a DOE (direct output enable) signal to the state machine 30. At the same time, the central processing unit 5 can send a chip selection (CS) signal to the state machine 30 for selecting the programmable logic device 3 to read out image data stored in the static random access memory 4. As a consequence, the central processing unit 5 also can receive and process communication signals from other peripherals except for those from the programmable logic device 3. Continually, the state machine 30 controls the JPEG stuff 34 to send a SOE (SRAM output enable) signal to the static random access memory 4. Then, the static random access memory 4 sends image data to the JPEG stuff 34 through the eight pins P [0..7]. The JPEG stuff 34 would compensate the image data from the static random access memory 4, becoming the standardized JPEG image data, and then sending to the central processing unit 5. Hence, the central processing unit 5 reads out the image data stored in the static random access memory 4 through the programmable logic device 3 by the direct memory access method until completing the reading cycle, i.e. reading over all the image data stored in the static random access memory 4. The timing diagram that the central processing unit 5 reads out the image data stored in the static random access memory 4 is shown in FIG. 4B.

Thereafter, at step 304, the state machine 30 sends a reading cycle completion signal to the digital camera module 2. Continually, at step 305, the digital camera module 2 sends a check command to the state machine 30 of the programmable logic device 3, checking the register state of the programmable logic device 3. At step 306, the state machine 30 sends a status value to the digital camera module 2, acknowledging if continuing to send image data. If it is yes, repeating steps 300 through 306.

Referring to FIG. 1 again, the image data read out by the central processing unit 5 from the static random access memory 4 can be transmitted to a remote connected terminal 7, through an ethernet 6, for further processing. The image data read out by the central processing unit 5 from the static random access memory 4 also can be transmitted to a remote monitoring center (not shown), such as a remote connected personal computer, through a wireless interface connected to the central processing unit 5, for example a PCMICA (personal computer memory card international association) interface 8, by a wireless communication network 9, such as an IEEE802.11b wireless communication network. A user can observe the video display from the remote connected personal computer in real time, control the present digital camera system 1 through the wireless communication network 9, and furthermore concurrently monitoring several digital camera systems 1 through the wireless communication network 9.

The embodiments are only used to illustrate the present invention, not intended to limit the scope thereof. Many modifications of the embodiments can be made without departing from the spirit of the present invention.

What is claimed is:

1. A digital camera system enabling remote monitoring, comprising:
a digital camera module;
a programmable logic device;
a buffer memory; and
a central processing unit;
wherein said digital camera module sends image data to said programmable logic device and stored in said buffer memory, said central processing unit reads the image data stored in said buffer memory through said programmable logic device and then transmits the image data to a remote monitoring center through a communication network.

2. The digital camera system of claim 1, wherein said digital camera module comprises an image capturing unit and an image processing/communication unit, said image capturing unit served for capturing image information of an object, said image processing/communication unit served for converting the image information captured by said image capturing unit to compressed digital image data, and then sending to said programmable logic device.

3. The digital camera system of claim 1, wherein said programmable logic device writes in the image data from said digital camera module in accordance with the writing operation of an NAND flash memory.

4. The digital camera system of claim 1, wherein said buffer memory comprises a static random access memory (SRAM).

5. The digital camera system of claim 1, wherein said programmable logic device comprises a state machine and a JPEG (Joint Photographic Experts Group) stuff, said state machine used for receiving, determining and processing communication signals between said programmable logic device, said digital camera module, said buffer memory and said central processing unit, and said JPEG stuff used for compensating the image data from said buffer memory to become the standardized JPEG image data.

6. The digital camera system of claim 1, wherein the image data read by said central processing unit is transmitted to said remote monitoring center through an ethernet.

7. The digital camera system of claim 1, wherein the image data read by said central processing unit is transmitted to said remote monitoring center by a wireless communication network.

8. The digital camera system of claim 7, wherein the image data read by said central processing unit is transmitted to said remote monitoring center by said wireless communication network through a PCMCIA interface.

9. The digital camera system of claim 7, wherein the image data read by said central processing unit is transmitted to said remote monitoring center by an IEEE802.11b wireless communication network.

10. The digital camera system of claim 7, wherein the image data read by said central processing unit is transmitted to said remote monitoring center by an IEEE802.11b wireless communication network through a PCMCIA interface.

11. An image data transmission method for a digital camera system enabling remote monitoring, wherein said digital camera system includes a digital camera module, a programmable logic device, a buffer memory and a central processing unit, said image data transmission method comprising:
said programmable logic device writes in image data from said digital camera module and storing in said buffer memory until the writing action is completed;
said central processing unit reads the image data stored in said buffer memory through said programmable logic device; and
said central processing unit transmits the image data read from said buffer memory through a communication network.

12. The image data transmission method of claim 11, wherein said programmable logic device writes in the image data from said digital camera module in accordance with the writing operation of an NAND flash memory.

13. The image data transmission method of claim 11, wherein said central processing unit reads the image data stored in said buffer memory through said programmable logic device by a direct memory access method.

14. The image data transmission method of claim 11, wherein said central processing unit transmits the image data read from said buffer memory through a cable communication network.

15. The image data transmission method of claim 14, wherein said central processing unit transmits the image data read from said buffer memory through an ethernet.

16. The image data transmission method of claim 11, wherein said central processing unit transmits the image data read from said buffer memory through a wireless communication network.

17. The image data transmission method of claim 15, wherein said central processing unit transmits the image data read from said buffer memory through an IEEE802.11b wireless communication network.
